(19) United States
(12) Patent Application Publication
(10) Pub. No.: US 2026/0265123 A1
(43) Pub. Date: Sep. 10, 2026

(54) CHEMICALLY STRENGTHENED GLASS

(71) Applicant: NIPPON ELECTRIC GLASS CO., LTD., Shiga (JP)

(72) Inventors: Kiyotaka KINOSHITA, Shiga (JP); Kazumi MAEDA, Shiga (JP); Kosei OSADA, Shiga (JP)

(21) Appl. No.: 18/876,802

(22) PCT Filed: Jun. 29, 2023
(86) PCT No.: PCT/JP2023/024226

§ 371 Date: Dec. 19, 2024

(30) Foreign Application Priority Data
Jul. 13, 2022 (JP) 2022-112453

(51) Int. Cl. C03C 21/00; C03C 10/00

(52) U.S. Cl. CPC C03C 21/002; C03C 10/0018; C03C 10/0027; C03C 10/0054

(57) ABSTRACT

A chemically tempered glass includes a compressive stress layer having a compressive stress in a surface layer portion and a tensile stress layer having a tensile stress in an inner portion. The chemically tempered glass has a temper filling rate F_{IOX} represented by Equation (1) of 0.75 or more and 1.00 or less:

$${F}_{IOX} = \frac{{U}_{CT}}{{U}_{CT limit}} = \frac{{\int }_{DOC}^{\frac{t}{2}} {σ ( x )}^{2} dx}{1.618 {K}_{1 C} - 0.121} \qquad ( 1 )$$

where, for the chemically tempered glass, U_{CT} represents a tensile square area [MPa²·m], U_{CT limit} represents an explosion threshold value [MPa²·m], “t” represents a thickness [m], DOC represents a depth of compression [m] of the compressive stress layer, “x” represents a depth [m] from a surface, σ(x) represents a compressive stress value [MPa] at a depth “x”, and K_{1C} represents a fracture toughness value [MPa·m^{1/2}] in a composition of a thickness center portion.

### TECHNICAL FIELD

The present invention relates to a chemically tempered glass.

### BACKGROUND ART

Chemically tempered glasses have been widely used as cover glasses of devices, such as various electronic terminals and display devices. The chemically tempered glass has a compressive stress layer formed through ion exchange treatment in its surface, and hence formation and propagation of cracks in the surface are suppressed, and high strength is obtained (for example, Patent Literature 1).

### CITATION LIST

Patent Literature 1: WO 2013/088856 A1

### SUMMARY OF INVENTION

### Technical Problem

As the strength of the chemically tempered glass is increased more, the chemically tempered glass is more liable to show such explosive behavior that the glass is broken into pieces at the time of fracture. In view of the foregoing, an attempt has hitherto been made to evaluate in advance the presence or absence of the explosive behavior at the time of fracture of the chemically tempered glass based on the tensile stress value of a tensile stress layer. However, it has been difficult to accurately evaluate in advance the presence or absence of the explosive behavior at the time of fracture of the chemically tempered glass with the tensile stress value. As a result, the related-art chemically tempered glass has had a problem in that suppression of the explosive behavior at the time of fracture and an increase in strength cannot both be achieved.

An object of the present invention is to provide a chemically tempered glass capable of achieving high strength while suppressing explosive behavior at the time of fracture.

### Solution to Problem

(1) According to one embodiment of the present invention, which has been devised in order to achieve the above-mentioned object, there is provided a chemically tempered glass, comprising a compressive stress layer having a compressive stress in a surface layer portion and comprising a tensile stress layer having a tensile stress in an inner portion, wherein the chemically tempered glass has a temper filling rate F_{IOX} represented by Equation (A) of 0.75 or more and 1.00 or less:

$${F}_{IOX} = \frac{{U}_{CT}}{{U}_{CT limit}} \qquad ( A )$$

where
   U_{CT} represents a tensile square area [MPa²·m] of the chemically tempered glass represented by Equation (B), and
   U_{CT limit} represents an explosion threshold value [MPa²·m] of the chemically tempered glass represented by Equation (C);

$${U}_{CT} = {\int }_{DOC}^{\frac{t}{2}} {σ ( x )}^{2} dx \qquad ( B )$$

$${U}_{CT limit} = 1.618 {K}_{1 C} - 0.121 \qquad ( C )$$

where
   “t” represents a thickness [m] of the chemically tempered glass,
   DOC represents a depth of compression [m] of the compressive stress layer of the chemically tempered glass,
   “x” represents a depth [m] from a surface of the chemically tempered glass,
σ(x) represents a compressive stress value [MPa] at a depth “x” of the chemically tempered glass, and
K_{1C} represents a fracture toughness value [MPa·m^{1/2}] in a composition of a thickness center portion of the chemically tempered glass.

The inventors of the present invention have made extensive investigations, and as a result, have found that the presence or absence of explosive behavior at the time of fracture of the chemically tempered glass can be accurately evaluated in advance with the temper filling rate F_{IOX} represented by Equation (A). Specifically, the inventors have found that when the temper filling rate F_{IOX} is more than 1, explosive behavior is liable to occur at the time of breakage of the chemically tempered glass, and when the temper filling rate F_{IOX} is 1 or less, explosive behavior is less liable to occur at the time of breakage of the chemically tempered glass. Accordingly, when the temper filling rate F_{IOX} is 1 or less as in the above-mentioned configuration, explosive behavior at the time of breakage of the chemically tempered glass can be almost certainly suppressed.

Meanwhile, also when the temper filling rate F_{IOX} is less than 0.75, explosive behavior at the time of breakage of the chemically tempered glass can be suppressed, but it becomes difficult to achieve high strength owing to insufficient chemical tempering. Accordingly, from the viewpoint of achieving high strength, it is required that the temper filling rate F_{IOX} be 0.75 or more as in the above-mentioned configuration.

(2) In the above-mentioned configuration (1), it is preferred that the tensile square area U_{CT} be 0.90 MPa²·m or more.

(3) In the above-mentioned configuration (1) or (2), it is preferred that the fracture toughness value K_{1C} be 0.80 MPa·m^{1/2} or more.

(4) In any one of the above-mentioned configurations (1) to (3), it is preferred that the depth of compression DOC of the compressive stress layer be 90 μm or more, and that the chemically tempered glass have a tensile stress value CT at a depth of t/2 of 80 MPa or more.

(5) In any one of the above-mentioned configurations (1) to (4), it is preferred that the thickness “t” be from 0.1 mm to 1.5 mm, that the chemically tempered glass have a compressive stress value CS in the surface of 700 MPa or more, that the chemically tempered glass have a compressive stress value CS₃₀ at a depth of 30 μm of 140 MPa or more, and that the chemically tempered glass have a compressive stress value CS₅₀ at a depth of 50 μm of 100 MPa or more.

(6) In any one of the above-mentioned configurations (1) to (5), it is preferred that the chemically tempered glass have a diffusion depth of layer DOLK of a potassium ion of 4 μm or more.

(7) In any one of the above-mentioned configurations (1) to (6), a stress profile of the chemically tempered glass obtained by measuring a stress from the surface in a depth direction, with a compressive stress being a positive number and a tensile stress being a negative number, may have an inflection portion.

(8) In any one of the above-mentioned configurations (1) to (7), the chemically tempered glass may comprise as a glass composition, in terms of mol %, 40% to 80% of SiO₂, 10% to 30% of Al₂O₃, 0% to 10% of B₂O₃, 0.1% to 25% of Na₂O, 0% to 10% of K₂O, 0.1% to 20% of Li₂O, 0% to 10% of MgO, and 0% to 10% of P₂O₅.

(9) In the above-mentioned configuration (8), it is preferred that the chemically tempered glass comprise as the glass composition, in terms of mol %, 50% to 70% of SiO₂, 10% to 20% of Al₂O₃, 0% to 3% of B₂O₃, 1% to 25% of Na₂O, 0% to 10% of K₂O, 3% to 12% of Li₂O, 0% to 5% of MgO, and 1% to 10% of P₂O₅.

(10) In any one of the above-mentioned configurations (1) to (7), the chemically tempered glass may comprise as a glass composition, in terms of mol %, 40% to 80% of SiO₂, 10% to 30% of Al₂O₃, 0% to 3% of B₂O₃, 5% to 25% of Na₂O, 0% to 5.5% of K₂O, 0% to 0.09% of Li₂O, and 0% to 10% of MgO.

(11) In any one of the above-mentioned configurations (1) to (7), the chemically tempered glass may be a crystallized glass.

(12) According to another embodiment of the present invention, there is provided a chemically tempered glass, comprising a compressive stress layer having a compressive stress in a surface layer portion and comprising a tensile stress layer having a tensile stress in an inner portion, wherein the chemically tempered glass has a temper filling rate F_{IOX} represented by Equation (D) of 0.75 or more and 1.00 or less:

$${F}_{IOX} = \frac{{U}_{CT}}{{U}_{CT limit}} \qquad ( D )$$

where
   U_{CT} represents a tensile square area [MPa²·m] of the chemically tempered glass represented by Equation (E), and
   U_{CT limit} represents an explosion threshold value [MPa²·m] of the chemically tempered glass represented by Equation (F);

$${U}_{CT} = {\int }_{DOC}^{\frac{t}{2}} {σ ( x )}^{2} dx \qquad ( E )$$

$${U}_{CT limit} = 1.618 {K}_{1 C} - 0.121 \qquad ( F )$$

where
   “t” represents a thickness [m] of the chemically tempered glass,
   DOC represents a depth of compression [m] of the compressive stress layer of the chemically tempered glass,
   “x” represents a depth [m] from a surface of the chemically tempered glass,
   σ(x) represents a compressive stress value [MPa] at a depth “x” of the chemically tempered glass, and
   K_{1C} represents a fracture toughness value [MPa·m^{1/2}] of a glass to be chemically tempered before chemical tempering.

### Advantageous Effects of Invention

According to the present invention, the chemically tempered glass capable of achieving high strength while suppressing explosive behavior at the time of fracture can be provided.

### BRIEF DESCRIPTION OF DRAWINGS

FIG. 1 is a schematic sectional view for illustrating a chemically tempered glass according to an embodiment of the present invention.

FIG. 2 is a conceptual graph showing an example of a stress profile of the chemically tempered glass according to the embodiment of the present invention.

FIG. 3 is a conceptual graph showing another example of the stress profile of the chemically tempered glass according to the embodiment of the present invention.

FIG. 4 is a flow diagram for illustrating a method of producing the chemically tempered glass according to the embodiment of the present invention.

FIG. 5 is a flow diagram for illustrating the method of producing the chemically tempered glass according to the embodiment of the present invention.

FIG. 6 is a graph showing a relationship between the number of broken pieces at the time of fracture of the chemically tempered glass and a tensile square area U_{CT}.

FIG. 7 is a view for illustrating a pen drop test.

FIG. 8 is a graph showing a relationship between an explosion threshold value U_{CT limit} and a fracture toughness value K_{1C} of the chemically tempered glass.

FIG. 9 is a view for illustrating an abrasion step at the time of measurement of abraded four-point bending strength.

FIG. 10 is a view for illustrating a bending fracture step at the time of measurement of the abraded four-point bending strength.

### DESCRIPTION OF EMBODIMENTS

An embodiment of the present invention is described below with reference to the drawings.

### <Chemically Tempered Glass>

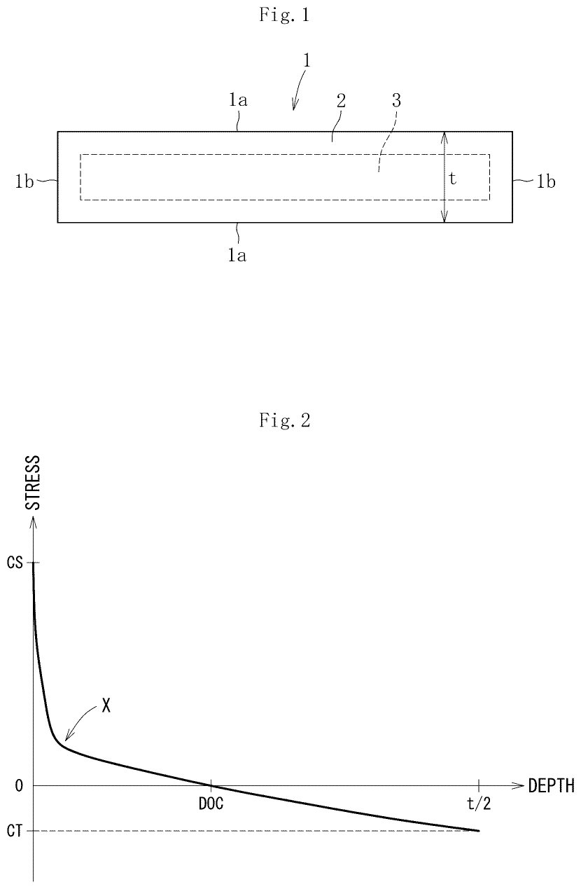

As illustrated in FIG. 1, a chemically tempered glass 1 according to this embodiment is a plate-shaped or sheet-shaped glass having been chemically tempered through ion exchange treatment. A thickness “t” of the chemically tempered glass 1 is not particularly limited, but is, for example, from 0.01 mm to 1.5 mm (preferably from 0.1 mm to 1.0 mm).

The chemically tempered glass 1 comprises a compressive stress layer 2 and a tensile stress layer 3. The compressive stress layer 2 is formed in a surface layer portion of the chemically tempered glass 1 comprising a main surface 1a and an end surface 1b. The tensile stress layer 3 is formed in an inner portion of the chemically tempered glass 1, that is, at a position deeper than the compressive stress layer 2. Herein, the “main surface 1a” refers to front and back surfaces excluding the end surface 1b in the entire surface of the glass.

A temper filling rate F_{IOX} of the chemically tempered glass 1 represented by Equation (1) is 0.75 or more and 1.00 or less. The temper filling rate F_{IOX} is preferably 0.76 or more and less than 1.00, 0.80 or more and 0.99 or less, or 0.85 or more and 0.98 or less. With this configuration, the chemically tempered glass 1 capable of achieving high strength while suppressing such explosive behavior that the glass is broken into pieces at the time of fracture can be obtained.

$${F}_{IOX} = \frac{{U}_{CT}}{{U}_{CT limit}} \qquad ( 1 )$$

$${U}_{CT} = {\int }_{DOC}^{\frac{t}{2}} {σ ( x )}^{2} dx \qquad ( 2 )$$

$${U}_{CT limit} = 1.618 {K}_{1 C} - 0.121 \qquad ( 3 )$$

U_{CT} represents a tensile square area [MPa²·m] of the chemically tempered glass,
U_{CT limit} represents an explosion threshold value [MPa²·m] of the chemically tempered glass,
“t” represents a thickness [m] of the chemically tempered glass,
DOC represents a depth of compression [m] of the compressive stress layer of the chemically tempered glass,
“x” represents a depth [m] from a surface of the chemically tempered glass,
σ(x) represents a compressive stress value [MPa] at a depth “x” of the chemically tempered glass, and
K_{1C} represents a fracture toughness value [MPa·m^{1/2}] of a glass to be chemically tempered before chemical tempering.

The tensile square area U_{CT} of the chemically tempered glass 1 is preferably 0.90 MPa²·m or more, 0.95 MPa²·m or more, 1.00 MPa²·m or more, or 1.05 MPa²·m or more. With this configuration, the mechanical strength of the chemically tempered glass 1, such as bending strength, is increased.

The fracture toughness value K_{1C} of the chemically tempered glass 1 is preferably 0.80 MPa·m^{1/2} or more, 0.81 MPa·m^{1/2} or more, 0.82 MPa·m^{1/2} or more, or 0.83 MPa·m^{1/2} or more. With this configuration, the mechanical strength of the chemically tempered glass 1, such as bending strength, is increased.

The depth of compression DOC of the compression stress layer of the chemically tempered glass 1 is preferably 90 μm or more, 100 μm or more, 105 μm or more, 110 μm or more, or 115 μm or more. With this configuration, the chemically tempered glass 1 is less liable to be broken even when a flaw is generated on the surface of the chemically tempered glass 1.

A diffusion depth of layer DOLK of a potassium ion of the chemically tempered glass 1 is preferably 4 μm or more, 4.5 μm or more, 5 μm or more, or 6 μm or more. With this configuration, the chemically tempered glass 1 is less liable to be broken even when a flaw is generated on the surface of the chemically tempered glass 1.

A tensile stress value CT at a depth of t/2 (sheet thickness center) of the chemically tempered glass 1 is preferably 80 MPa or more, 85 MPa or more, 90 MPa or more, or 95 MPa or more. With this configuration, there are tendencies that a surface compressive stress is easily increased and high strength is easily obtained. Meanwhile, when the CT is excessively increased, the chemically tempered glass 1 is liable to show explosive behavior at the time of fracture. Accordingly, the CT is preferably 125 MPa or less, 120 MPa or less, 115 MPa or less, or 110 MPa or less. However, the presence or absence of explosive behavior at the time of breakage of the chemically tempered glass 1 cannot be accurately evaluated with the value of the CT, and hence it is required to consider the value of the above-mentioned F_{IOX}.

A compressive stress value CS in the surface of the chemically tempered glass 1 is preferably 700 MPa or more, 750 MPa or more, 800 MPa or more, or 850 MPa or more. A compressive stress value CS₃₀ at a depth of 30 μm of the chemically tempered glass 1 is preferably 140 MPa or more, 150 MPa or more, 160 MPa or more, or 170 MPa or more. A compressive stress value CS₅₀ at a depth of 50 μm of the chemically tempered glass 1 is preferably 100 MPa or more, 105 MPa or more, 110 MPa or more, or 115 MPa or more. With this configuration, the mechanical strength of the chemically tempered glass 1, such as bending strength or drop strength, is increased.

Herein, the CS, the DOC, the DOLK, the CT, and the U_{CT} may each be derived, for example, based on a value measured with a surface stress meter (e.g., FSM-6000LE manufactured by Orihara Industrial Co., Ltd.), or a synthesized value of values measured with the surface stress meter and a scattered light photoelastic stress meter (e.g., SLP-1000 manufactured by Orihara Industrial Co., Ltd.). The K_{1C} is a value measured by an indentation fracture method (IF method) in conformity with JIS R1607, and is an average value over ten times of measurement.

The fracture toughness value K_{1C} may be measured, for example, by an indentation fracture method (IF method) in conformity with JIS R1607. The fracture toughness value K_{1C} may also be measured by any other known method. For example, the fracture toughness value K_{1C} may also be measured by a SEPB method.

In addition, the fracture toughness value K_{1C} may be determined through calculation based on a Miller index. In order to measure the fracture toughness value K_{1C} in the composition of the center portion, a glass sample having the composition is processed into predetermined dimensions, and is subjected to a measurement test by the above-mentioned method. However, when it is difficult to process the glass having been tempered and having high strength into predetermined dimensions, the calculation based on a Miller index may be used as an alternative method. It is known that there is a certain correlation between the fracture toughness of glass or glass ceramic and its Miller index (Mecholsky et al., J. Mater. Sci., 11, 1310-1319 (1976)). In the present invention, the fracture toughness value K_{1C} may be determined from the following relational equation (4) based on a Miller index Aₘ. The Miller index Aₘ may be determined by observing a Miller radius of a cross section, which is obtained when a glass sample having arbitrary dimensions is ruptured under a predetermined bending stress.

$${A}_{m} = 3.4141 {K}_{1 C} + 1.2 \; 28 \qquad ( 4 )$$

K_{1C} represents a fracture toughness value (MPa/m^{1/2}), and
Aₘ represents a Miller index (MPa·m^{1/2})

The abraded four-point bending strength of the chemically tempered glass 1 is preferably 190 MPa or more, 200 MPa or more, 210 MPa or more, or 220 MPa or more. With this configuration, the chemically tempered glass 1 can be suitably used for a foldable-type device that is utilized by being folded.

An example of a stress profile of the chemically tempered glass 1 obtained by measuring a stress from the surface in a depth direction, with a compressive stress being a positive number and a tensile stress being a negative number, is shown in FIG. 2. Herein, the magnitude of each stress is represented by an absolute value unless otherwise stated.

As shown in FIG. 2, in order to achieve a large CS and a deep DOC, the stress profile of the chemically tempered glass 1 has an inflection portion X, which is largely inflected. That is, the stress profile of the chemically tempered glass 1 is segmented into a plurality of zones having different slopes when being subjected to linear approximation. With this configuration, the drop strength of the chemically tempered glass 1 is significantly increased. Accordingly, when the chemically tempered glass is used, for example, as a cover glass of a smartphone, breakage probability at the time of dropping can be significantly reduced.

In the stress profile of the chemically tempered glass 1, a compressive stress becomes the maximum (CS) in the surface, the stress is gradually reduced as a depth from the surface becomes deeper, and the stress becomes zero at a depth corresponding to the DOC. That is, the DOC is synonymous with the depth of the compressive stress layer 2. In a region deeper than the DOC, the tensile stress layer 3 having a tensile stress extends.

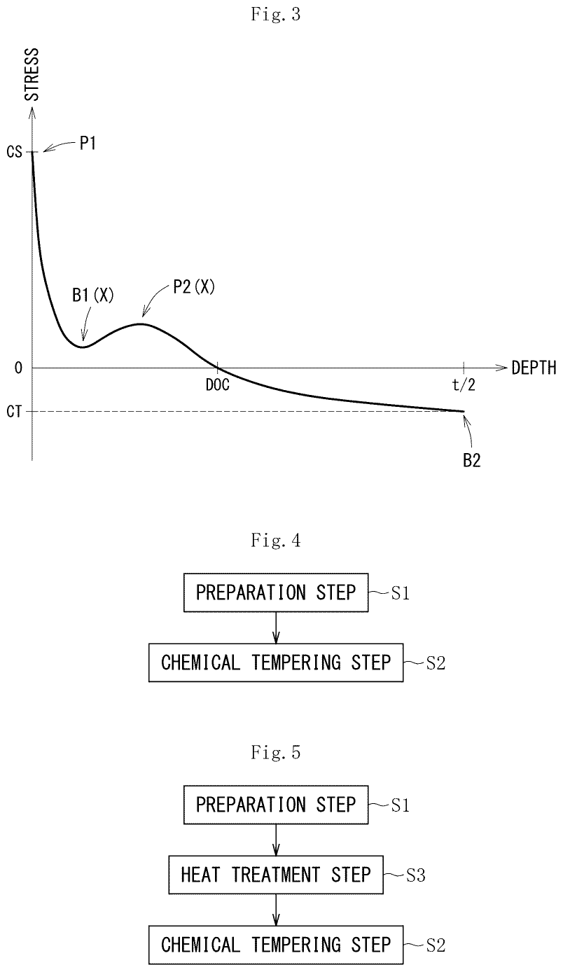

The stress profile of the chemically tempered glass 1 is not limited to the aspect shown in FIG. 2. For example, as shown in FIG. 3, the stress profile of the chemically tempered glass 1 may be a stress profile having a first peak P1, a first bottom B1, a second peak P2, and a second bottom B2 in the stated order from a surface side. The first peak P1 is formed in the surface of the chemically tempered glass 1. The second bottom B2 is formed in the sheet thickness center (t/2) of the chemically tempered glass 1. The first bottom B1 and the second peak P2 are formed in the range of from the surface to the DOC. In the case of such stress profile, a plurality of inflection portions X are formed.

The chemically tempered glass 1 is, for example, preferably an aluminosilicate glass.

As an example of the aluminosilicate glass, the chemically tempered glass 1 may comprise as the composition of the center portion of the glass, in terms of mol %, 40% to 80% of SiO₂, 10% to 30% of Al₂O₃, 0% to 10% of B₂O₃, 0.1% to 25% of Na₂O, 0% to 10% of K₂O, 0.1% to 20% of Li₂O, 0% to 10% of MgO, and 0% to 10% of P₂O₅.

In the present invention, the composition of the center portion of the chemically tempered glass 1 refers to the glass composition of a thickness center portion of the chemically tempered glass 1. The composition of the center portion of the chemically tempered glass 1 is the same as the glass composition of a glass to be chemically tempered before chemical tempering. In addition, in the present invention, the fracture toughness value in the composition of the center portion of the chemically tempered glass refers to the fracture toughness value of a glass sample having the composition of the center portion in an untempered state, and is the same as the fracture toughness value of the glass to be chemically tempered before chemical tempering.

More specifically, the chemically tempered glass 1 may comprise as the composition of the center portion, in terms of mol %, 50% to 70% of SiO₂, 10% to 20% of Al₂O₃, 0% to 3% of B₂O₃, 1% to 25% of Na₂O, 0% to 10% of K₂O, 3% to 12% of Li₂O, 0% to 5% of MgO, and 1% to 10% of P₂O₅.

SiO₂ is a component that forms a glass network. When the content of SiO₂ is too small, vitrification does not occur easily, and a thermal expansion coefficient becomes too high, with the result that thermal shock resistance is liable to be reduced. Accordingly, a suitable lower limit of the content range of SiO₂ is, in terms of mol %, 40% or more, 50% or more, 55% or more, 57% or more, or 59% or more, particularly 61% or more. Meanwhile, when the content of SiO₂ is too large, meltability and formability are liable to be reduced, and the thermal expansion coefficient is excessively reduced, with the result that it becomes difficult to match the thermal expansion coefficient with those of peripheral materials. Accordingly, a suitable upper limit of the content range of SiO₂ is, in terms of mol %, 80% or less, 70% or less, 68% or less, 66% or less, 65% or less, or 64.5% or less.

Al₂O₃ is a component that improves ion exchange performance, and is also a component that increases a strain point, a Young's modulus, fracture toughness, and a Vickers hardness. Accordingly, a suitable lower limit of the content range of Al₂O₃ is, in terms of mol %, 10% or more, 12% or more, 13% or more, 14% or more, 14.4% or more, 15% or more, 15.3% or more, 15.6% or more, 16% or more, 16.5% or more, 17% or more, 17.2% or more, 17.5% or more, 17.8% or more, 18% or more, more than 18%, 18.3% or more, 18.5% or more, 18.6% or more, 18.7% or more, or 18.8% or more. Meanwhile, when the content of Al₂O₃ is too large, a viscosity at high temperature is increased, with the result that the meltability and the formability are liable to be reduced. In addition, a devitrified crystal is liable to precipitate in the glass, and it becomes difficult to form the glass into a sheet shape by an overflow down-draw method or the like. Particularly when the glass is formed into a sheet shape by an overflow down-draw method involving using an alumina-based refractory as a forming body refractory, a devitrified crystal of spinel is liable to precipitate at an interface with the alumina-based refractory. Further, acid resistance is reduced, with the result that it becomes difficult to apply the glass to an acid treatment step. Accordingly, a suitable upper limit of the content range of Al₂O₃ is, in terms of mol %, 30% or less, 25% or less, 21% or less, 20.5% or less, 20% or less, 19.9% or less, 19.5% or less, 19.0% or less, or 18.9% or less.

B₂O₃ is a component that reduces the viscosity at high temperature and a density, and stabilizes the glass to cause less precipitation of a crystal, to thereby reduce a liquidus temperature. When the content of B₂O₃ is too small, a depth of layer at the time of ion exchange between a Li ion in the glass and a Na ion in a molten salt becomes excessively large, and as a result, the compressive stress value of the compressive stress layer is liable to be reduced. In addition, the glass may be unstable, and devitrification resistance may be reduced. Accordingly, a suitable lower limit of the content range of B₂O₃ is, in terms of mol %, 0% or more, 0.1% or more, 0.2% or more, 0.5% or more, 0.6% or more, 0.7% or more, 0.8% or more, 0.9% or more, or 1% or more. Meanwhile, when the content of B₂O₃ is too large, the depth of layer may be reduced. In particular, efficiency of ion exchange between a Na ion in the glass and a K ion in the molten salt is liable to be reduced, and the depth of the compressive stress layer is liable to be reduced. Accordingly, a suitable upper limit of the content range of B₂O₃ is, in terms of mol %, 10% or less, 5% or less, 4% or less, 3.8% or less, 3.5% or less, 3.3% or less, 3.2% or less, 3.1% or less, 3% or less, or 2.9% or less.

Na₂O is an ion exchange component, and is also a component that reduces the viscosity at high temperature to improve the meltability and the formability. In addition, Na₂O is a component that improves the devitrification resistance, and is particularly a component that suppresses devitrification caused by a reaction with the alumina-based refractory. Accordingly, a suitable lower limit of the content range of Na₂O is, in terms of mol %, 0.1% or more, 1% or more, 3% or more, 4% or more, 5% or more, 6% or more, 7% or more, 7.5% or more, 8% or more, 8.5% or more, 8.8% or more, or 9% or more. Meanwhile, when the content of Na₂O is too large, the thermal expansion coefficient is excessively increased, and the thermal shock resistance is liable to be reduced. In addition, the glass composition loses its component balance, and the devitrification resistance may be reduced contrarily. Accordingly, a suitable upper limit of the content range of Na₂O is, in terms of mol %, 25% or less, 21% or less, 20% or less, 19% or less, 18% or less, 15% or less, 13% or less, 11% or less, or 10% or less.

K₂O is a component that reduces the viscosity at high temperature to improve the meltability and the formability. However, when the content of K₂O is too large, the thermal expansion coefficient is excessively increased, and the thermal shock resistance is liable to be reduced. In addition, the compressive stress value of the compressive stress layer on the outermost surface is liable to be reduced. Accordingly, a suitable upper limit of the content range of K₂O is, in terms of mol %, 10% or less, 7% or less, 6% or less, 5% or less, 4% or less, 3% or less, 2% or less, 1.5% or less, 1% or less, less than 1%, 0.5% or less, or less than 0.1%. When the viewpoint of increasing the depth of layer is emphasized, a suitable lower limit of the content range of K₂O is, in terms of mol %, 0% or more, 0.1% or more, 0.3% or more, or 0.5% or more.

Li₂O is an ion exchange component, and is particularly a component for obtaining a large depth of layer through ion exchange between a Li ion in the glass and a Na ion in the molten salt. In addition, Li₂O is a component that reduces the viscosity at high temperature to improve the meltability and the formability, and is also a component that increases the Young's modulus. Accordingly, a suitable lower limit of the content range of Li₂O is, in terms of mol %, 0.1% or more, 3% or more, 4% or more, 5% or more, 5.5% or more, 6.5% or more, 7% or more, 7.3% or more, 7.5% or more, 7.8% or more, or 8% or more. A suitable upper limit of the content range of Li₂O is, in terms of mol %, 20% or less, 15% or less, 13% or less, 12% or less, 11.5% or less, 11% or less, 10.5% or less, less than 10%, 9.9% or less, 9% or less, or 8.9% or less.

MgO is a component that reduces the viscosity at high temperature to improve the meltability and the formability, and increases the strain point and the Vickers hardness. Among alkaline earth metal oxides, MgO is a component that has a high improving effect on the ion exchange performance. However, when the content of MgO is too large, the devitrification resistance is liable to be reduced, and in particular, it becomes difficult to suppress devitrification caused by a reaction with alumina-based refractory. Accordingly, a suitable content of MgO is, in terms of mol %, from 0% to 10%, from 0% to 5%, from 0.1% to 4%, from 0.2% to 3.5%, or from 0.5% to less than 3%.

P₂O₅ is a component that improves the ion exchange performance, and is particularly a component that increases the depth of layer. Further, P₂O₅ is a component that improves the acid resistance as well. When the content of P₂O₅ is too small, the ion exchange performance may not be sufficiently exhibited. In particular, the efficiency of ion exchange between a Na ion in the glass and a K ion in the molten salt is liable to be reduced, and the depth of the compressive stress layer is liable to be reduced. In addition, the glass may become unstable, and the devitrification resistance may be reduced. Accordingly, a suitable lower limit of the content range of P₂O₅ is, in terms of mol %, 0% or more, 0.1% or more, 0.4% or more, 0.7% or more, 1% or more, 1.2% or more, 1.4% or more, 1.6% or more, 2% or more, 2.3% or more, 2.5% or more, or 3% or more. Meanwhile, when the content of P₂O₅ is too large, the glass is liable to undergo phase separation, or water resistance is liable to be reduced. In addition, the depth of layer at the time of ion exchange between a Li ion in the glass and a Na ion in the molten salt becomes excessively large, and as a result, the compressive stress value of the compressive stress layer is liable to be reduced. Accordingly, a suitable upper limit of the content range of P₂O₅ is, in terms of mol %, 10% or less, 5% or less, 4.5% or less, or 4% or less.

As another example of the aluminosilicate glass, the chemically tempered glass 1 may comprise as the composition of the center portion, in terms of mol %, 40% to 80% of SiO₂, 10% to 30% of Al₂O₃, 0% to 3% of B₂O₃, 5% to 25% of Na₂O, 0% to 5.5% of K₂O, 0% to 0.09% of Li₂O, and 0% to 10% of MgO. That is, the chemically tempered glass 1 may be a glass substantially free of Li₂O. However, in order to achieve a large CS and a deep DOC in the chemically tempered glass 1, the chemically tempered glass 1 preferably comprises Li₂O.

The chemically tempered glass 1 may be a crystallized glass. The crystallized glass is a glass comprising an inorganic crystal precipitated by subjecting an amorphous glass to heat treatment (crystallization treatment), and comprises the inorganic crystal in the glass. Herein, the “amorphous glass” refers to a glass in which a diffraction peak showing a crystal is not observed by powder X-ray diffractometry.

As an example of the crystallized glass formed of an aluminosilicate glass, the chemically tempered glass 1 may comprise as the composition of the center portion, in terms of mass %, 58% to 70% of SiO₂, 15% to 30% of Al₂O₃, 2% to 10% of Li₂O, 0% to 10% of Na₂O, 0% to 10% of K₂O, 0% to 15% of Na₂O+K₂O, 0% to 15% of MgO+CaO+SrO+BaO+ZnO, 0.1% to 6% of SnO₂, 0.5% to 6% of ZrO₂, 0% to 4% of TiO₂, and 0% to 6% of P₂O₅, and may have a crystallinity of from 1% to 95%. The crystallinity may be evaluated with an X-ray diffractometer (automatic multipurpose horizontal X-ray diffractometer SmartLab, manufactured by Rigaku Corporation).

The glass to be chemically tempered before chemical tempering preferably has the glass composition given as an example of the composition of the center portion of the chemically tempered glass 1 so that the chemically tempered glass 1 has the above-mentioned composition of the center portion.

### <Method of Producing Chemically Tempered Glass>

As illustrated in FIG. 4, a method of producing the chemically tempered glass according to this embodiment comprises a preparation step S1 and a chemical tempering step S2.

In the preparation step S1, a glass to be chemically tempered is prepared. The glass to be chemically tempered is a glass having substantially the same shape and dimensions as those of the above-mentioned chemically tempered glass 1 and being formed of substantially the same glass composition as that of the chemically tempered glass 1. The “glass to be chemically tempered” refers to a glass before ion exchange treatment, and the “chemically tempered glass” refers to a glass after ion exchange treatment.

The glass to be chemically tempered is obtained, for example, by cutting and processing a plate-shaped or sheet-shaped mother glass obtained by a forming method, such as an overflow down-draw method, a slot down-draw method, a float method, or a redraw method, into small-piece glasses. In order to obtain a flat and smooth surface, an overflow down-draw method is preferably used as the forming method. When being formed by the overflow down-draw method, the glass to be chemically tempered has a formed merged surface in an inner portion.

In the chemical tempering step S2, the glass to be chemically tempered is chemically tempered through ion exchange treatment to provide the chemically tempered glass 1 comprising the compressive stress layer 2 and the tensile stress layer 3. The number of times of the ion exchange treatment is not particularly limited, and may be only 1, or may be a plurality of times. When the ion exchange treatment is performed a plurality of times, the number of times of the ion exchange treatment is preferably 2.

When the glass to be chemically tempered comprises a Na ion and a Li ion in the glass, and is subjected to the ion exchange treatment a plurality of times, it is preferred to perform first ion exchange treatment involving immersing the glass to be chemically tempered in a molten salt containing a NaNO₃ molten salt, followed by second ion exchange treatment involving immersing the glass to be chemically tempered in a molten salt containing a KNO₃ molten salt. With this configuration, a large CS and a deep DOC are easily achieved.

In particular, it is preferred that, in the first ion exchange treatment, the glass to be chemically tempered be immersed in a NaNO₃ molten salt or a mixed molten salt of NaNO₃ and KNO₃, and that, in the second ion exchange treatment, the glass to be chemically tempered be immersed in a mixed molten salt of KNO₃ and LiNO₃. With this configuration, the chemically tempered glass 1 showing such a stress profile having the inflection portion X as shown in FIG. 2 can be obtained.

In the first ion exchange step, a Li ion in the glass and a Na ion in the molten salt are ion exchanged. When the mixed molten salt of NaNO₃ and KNO₃ is used, a Na ion in the glass and a K ion in the molten salt are further ion exchanged. Herein, the ion exchange between a Li ion in the glass and a Na ion in the molten salt has a higher speed and higher ion exchange efficiency than the ion exchange between a Na ion in the glass and a K ion in the molten salt. In the second ion exchange step, a Na ion in the vicinity of the surface of the glass (in a shallow region from the surface to 20% of the thickness “t”) and a Li ion in the molten salt are ion exchanged, and besides, a Na ion in the vicinity of the surface of the glass (in a shallow region from the uppermost surface to 20% of the sheet thickness) and a K ion in the molten salt are ion exchanged. That is, in the second ion exchange step, while a Na ion in the vicinity of the surface of the glass is caused to escape, a K ion having a large ionic radius can be introduced. As a result, while a large depth of layer is maintained, a compressive stress value in the outermost surface can be increased.

In the first ion exchange step, a treatment temperature (temperature of the molten salt) is preferably from 360° C. to 400° C., and a treatment time period (ion exchange time period) is preferably from 30 minutes to 6 hours. In the second ion exchange step, a treatment temperature is preferably from 370° C. to 400° C., and a treatment time period is preferably from 15 minutes to 3 hours.

In order to form the stress profile having the inflection portion X, the concentration of NaNO₃ is preferably higher than the concentration of KNO₃ in the mixed molten salt of NaNO₃ and KNO₃ used in the first ion exchange step, and the concentration of KNO₃ is preferably higher than the concentration of LiNO₃ in the mixed molten salt of KNO₃ and LiNO₃ used in the second ion exchange step.

In the mixed molten salt of NaNO₃ and KNO₃ used in the first ion exchange step, the concentration of KNO₃ is preferably 0 mass % or more, 0.5 mass % or more, 1 mass % or more, 5 mass % or more, 7 mass % or more, 10 mass % or more, 15 mass % or more, or from 20 mass % to 90 mass %. When the concentration of KNO₃ is too high, a compressive stress value formed through ion exchange between a Li ion in the glass and a Na ion in the molten salt may be excessively reduced. In addition, when the concentration of KNO₃ is too low, it may become difficult to perform stress measurement with a surface stress meter.

In the mixed molten salt of KNO₃ and LiNO₃ used in the second ion exchange step, the concentration of LiNO₃ is preferably from more than 0 mass % to 5 mass %, from more than 0 mass % to 3 mass %, from more than 0 mass % to 2 mass %, or from 0.1 mass % to 1 mass %. When the concentration of LiNO₃ is too low, it is difficult for a Na ion in the vicinity of the surface of the glass to escape. Meanwhile, when the concentration of LiNO₃ is too high, a compressive stress value formed through ion exchange between a Na ion in the vicinity of the surface of the glass and a K ion in the molten salt may be excessively reduced.

When the glass to be chemically tempered comprises a Na ion in the glass and is subjected to ion exchange treatment only once, it is preferred to perform ion exchange treatment involving immersing the glass to be chemically tempered in a molten salt containing a KNO₃ molten salt. In this case, a Na ion in the glass and a K ion in the molten salt are ion exchanged.

When the glass to be chemically tempered comprises a Li ion in the glass and is subjected to ion exchange treatment only once, it is preferred to perform ion exchange treatment involving immersing the glass to be chemically tempered in a molten salt containing a NaNO₃ molten salt. In this case, a Li ion in the glass and a Na ion in the molten salt are ion exchanged.

The conditions of the chemical tempering step S2 are preferably appropriately adjusted so that the temper filling rate F_{IOX} of the chemically tempered glass 1 becomes 0.75 or more and 1.00 or less. For example, the kind and concentration of the molten salt, the treatment temperature, or the treatment time period in the ion exchange treatment is adjusted.

When the chemically tempered glass 1 is a crystallized glass, as illustrated in FIG. 5, the method of producing the chemically tempered glass further comprises a heat treatment (crystallization) step S3 after the preparation step S1 and before the chemical tempering step S2 as described above. In the heat treatment step S3, for example, the glass to be chemically tempered formed of an amorphous glass is subjected to heat treatment at from 700° C. to 840° C. for from 0.1 hour to 15 hours. Thus, at least one kind selected from a β-eucryptite solid solution, a β-spodumene solid solution, and zirconia is precipitated in the glass as a precipitated crystal.

### EXAMPLES

A glass article according to the present invention is described below by way of Examples. The following Examples are merely examples, and the present invention is by no means limited to the following Examples.

### <Production of Glass to be Chemically Tempered>

A glass to be chemically tempered having a glass composition shown in Table 1 was prepared.

TABLE 1

| mol % | A | B | C | D |
|---|---|---|---|---|
| SiO₂ | 61.14 | 60.35 | 67.87 | 67.95 |
| Al₂O₃ | 13.52 | 18.90 | 12.10 | 22.30 |
| B₂O₃ | 0.59 | 0.20 | 7.50 | |
| MgO | 3.52 | 0.40 | 2.50 | 1.25 |
| Li₂O | 0.02 | 7.20 | 7.70 | 3.68 |
| Na₂O | 15.24 | 8.20 | 2.20 | 0.67 |
| K₂O | 3.23 | 0.40 | | |
| Zro₂ | | | | 2.62 |
| P₂O₅ | 2.62 | 4.30 | | 0.40 |
| SnO₂ | 0.12 | 0.05 | 0.03 | 1.13 |
| Cl | | | 0.10 | |

Specifically, glass raw materials shown in Table 1 were blended and melted in a test melting furnace. After that, the resultant molten glass was formed into a plate shape or a sheet shape, and cut into a predetermined size to provide a glass to be chemically tempered. The glass to be chemically tempered having the composition D was further subjected to heat treatment at 780° C. for 3 hours, followed by heat treatment at 830° C. for 1 hour to be turned into a crystallized glass. The thicknesses of the glasses to be chemically tempered having the compositions A to C were each set to 0.7 mm, and the thickness of the glass to be chemically tempered having the composition D was set to 0.6 mm. In addition, glass samples to be chemically tempered obtained as described above were each measured for a fracture toughness value K_{1C}. The resultant fracture toughness value K_{1C} refers to a fracture toughness value in the composition of a thickness center portion of a chemically tempered glass after chemical tempering described later.

### <Derivation of Equation (1)>

The above-mentioned glass to be chemically tempered was subjected to ion exchange treatment by changing the kind of a molten salt, a treatment time period (immersion time period), or a treatment temperature. Thus, a chemically tempered glass (measurement sample) was produced.

Specifically, all the glasses to be chemically tempered were subjected to ion exchange treatment only once. The glasses to be chemically tempered having the compositions A and B were each subjected to ion exchange by being immersed in a KNO₃ molten salt. The glass to be chemically tempered having the composition C was subjected to ion exchange by being immersed in a NaNO₃ molten salt. The glass to be chemically tempered having the composition D (crystallized glass) was subjected to ion exchange by being immersed in a mixed molten salt of KNO₃ and LiNO₃.

The treatment time period (immersion time period in the molten salt) of the glass to be chemically tempered having the composition A was adjusted to from 4 hours to 96 hours. The treatment time period of the glass to be chemically tempered having the composition B was adjusted to from 2 hours to 64 hours. The treatment time period of the glass to be chemically tempered having the composition C was adjusted to from 6 hours to 10 hours. The treatment time period of the glass to be chemically tempered having the composition D was set to 90 hours or 120 hours.

The treatment temperature (temperature of the molten salt) of each of the glasses to be chemically tempered having the compositions A and B was set to 450° C. The treatment temperature of the glass to be chemically tempered having the composition C was set to 380° C. The treatment temperature of the glass to be chemically tempered having the composition D was set to 430° C.

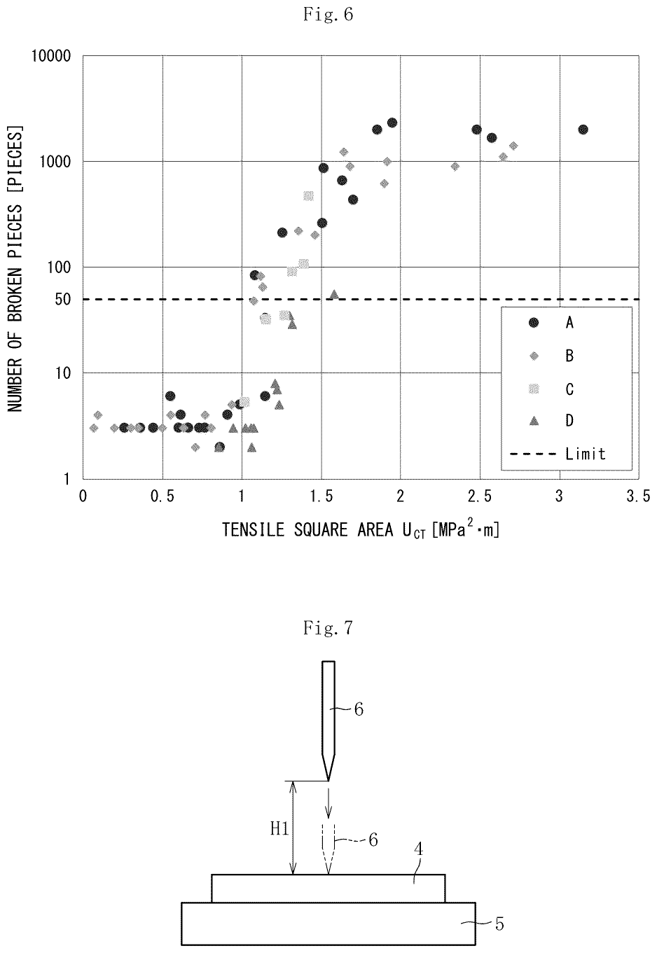

Moreover, for each of the chemically tempered glasses produced as described above, a relationship between the number of broken pieces at the time of fracture in a pen drop test and a tensile square area U_{CT} was examined. The results are shown in FIG. 6. In FIG. 6, the abscissa and the ordinate represent the U_{CT} and the number of broken pieces at the time of fracture, respectively.

As illustrated in FIG. 7, in the pen drop test, under the state in which a chemically tempered glass 4 corresponding to each of the compositions A to D was placed on a stone surface plate 5, the penpoint of a diamond pen 6 was dropped onto and caused to collide with the main surface of the chemically tempered glass 4, to thereby fracture the chemically tempered glass 4. Then, the number of broken pieces of the chemically tempered glass 4 at this time was measured. The chemically tempered glass 4 had a rectangular shape measuring 26 mm by 76 mm. The thickness of the chemically tempered glass 4 was set to 0.7 mm (measurement samples corresponding to the compositions A to C) or 0.6 mm (measurement sample corresponding to the composition D). A product available under the product number 579-50-62-1 (weight: 10 g) from Tokyo Garasu Kikai Co., Ltd. (TGK) was used as the diamond pen 6. A drop height H1 of the diamond pen 6 was set to 20 mm. As a measurement method for the number of broken pieces, there may be used, for example, a method involving visually measuring the number of broken pieces of the chemically tempered glass 4, and as well, a method involving randomly measuring the areas of the broken pieces having been broken and estimating the number of broken pieces.

The tensile square area U_{CT} of the chemically tempered glass 4 was determined from Equation (2). At this time, the stress profile of the chemically tempered glass 4 was derived based on a value obtained with FSM-6000LE (manufactured by Orihara Industrial Co., Ltd.), or a synthesized value of values obtained with FSM-6000LE and SLP-2000 (manufactured by Orihara Industrial Co., Ltd.).

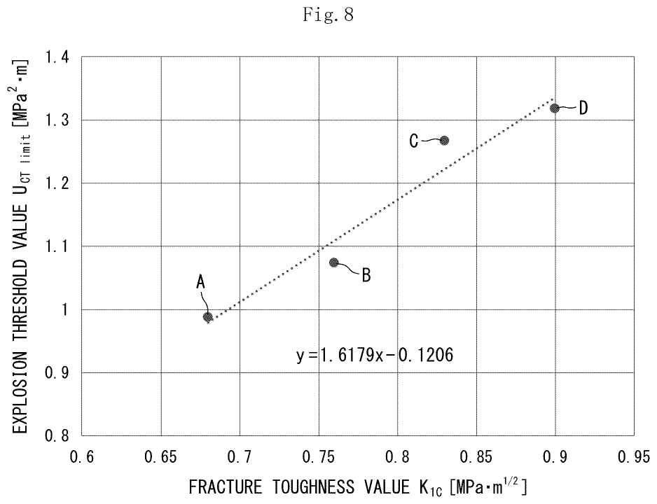

For each of the chemically tempered glasses 4 having the compositions A to D, the maximum value of the tensile square area U_{CT} at which the number of broken pieces necessarily became less than 50 (explosion threshold value U_{CT limit}) was read from the results of FIG. 6, and its relationship with the fracture toughness value K_{1C} was examined. A graph obtained by plotting the results, with the abscissa representing the fracture toughness value K_{1C} and the ordinate representing the explosion threshold value U_{CT limit}, is shown in FIG. 8. It is experimentally known that when 50 or more broken pieces are measured within 10 seconds immediately after fracture, the glass tends to show such explosive behavior that the glass is broken into pieces at the time of fracture.

It is found also from the results of FIG. 8 that there is a correlation between the fracture toughness value K_{1C} and the explosion threshold value U_{CT limit}. Moreover, when the plots of the figure are subjected to linear approximation, a relational equation y=1.618x−0.121 [MPa²·m] is obtained. That is, as shown in Equation (3), a relational equation U_{CT limit}=1.618K_{1C}−0.121 [MPa²·m] is obtained. Accordingly, when the tensile square area U_{CT} of the chemically tempered glass is equal to or less than the U_{CT} limit represented by 1.618K_{1C}−0.121, the chemically tempered glass is less liable to show explosive behavior at the time of breakage. That is, as shown in Equation (1), the fact that the temper filling rate F_{IOX} defined by U_{CT}/U_{CT limit} is 1 or less may serve as an indicator for accurately evaluating the presence or absence of explosive behavior at the time of breakage of the chemically tempered glass.

Herein, the relationship between the fracture toughness value K_{1C} of each of the chemically tempered glasses and the explosion threshold value U_{CT limit} thereof calculated from Equation (3) is shown in Table 2.

TABLE 2

| Composition | K_{1C} [MPa · m^{1/2}] | U_{CT limit} [MPa² · m] |
|---|---|---|
| A | 0.68 | 0.98 |
| B | 0.76 | 1.11 |
| C | 0.83 | 1.22 |
| D | 0.9 | 1.34 |

### <Characteristic Evaluation of Chemically Tempered Glass Using Equation (1)>

The above-mentioned glasses to be chemically tempered (compositions B, C, and D) were each subjected to chemical tempering under the conditions shown in Table 3. Thus, chemically tempered glasses were produced and evaluated for various characteristics. Samples Nos. 1, 2, and 4 to 8 are Examples of the present invention, and Sample No. 3 is Comparative Example.

TABLE 3

| | | No. 1 | No. 2 | No. 3 | No. 4 | No. 5 | No. 6 | No. 7 | No. 8 |
|---|---|---|---|---|---|---|---|---|---|
| Composition | | D | D | D | D | C | C | C | B |
| K_{1C} [MPa · m^{1/2}] | | 0.9 | 0.9 | 0.9 | 0.9 | 0.83 | 0.83 | 0.83 | 0.76 |
| U_{CT limit} [MPa² · m] | | 1.34 | 1.34 | 1.34 | 1.34 | 1.22 | 1.22 | 1.22 | 1.11 |
| U_{CT} [MPa² · m] | | 1.1 | 1.2 | 1.5 | 1.0 | 1.2 | 1.0 | 0.9 | 0.85 |
| F_{IOX} | | 0.85 | 0.86 | 1.12 | 0.75 | 0.96 | 0.85 | 0.77 | 0.76 |
| Thickness [mm] | | 0.6 | 0.6 | 0.6 | 0.6 | 0.7 | 0.7 | 0.7 | 0.7 |
| First ion | Moten salt [wt %] | Na100 | Na100 | Na100 | Na95/Li5 | Na100 | Na100 | Na100 | Na100 |
| exchange | Treatment | 430 | 430 | 430 | 430 | 380 | 380 | 380 | 380 |
| step | temperature [° C.] | | | | | | | | |
| | Treatment time | 60 | 70 | 90 | 90 | 540 | 540 | 540 | 180 |
| | period [min.] | | | | | | | | |
| Second ion | Moten salt [wt %] | — | — | — | — | K100 | K100 | K100 | K100 |
| exchange | Treatment | — | — | — | — | 430 | 430 | 430 | 380 |
| step | temperature [° C.] | | | | | | | | |
| | Treatment time | — | — | — | — | 15 | 30 | 45 | 15 |
| | period [min.] | | | | | | | | |

| | | | | | | | | |
|---|---|---|---|---|---|---|---|---|
| CS [MPa] | 386.5 | 355.4 | 355.0 | 292.4 | 853.4 | 815.4 | 772.0 | 992.5 |
| DOLK [μm] | Unmeasured | Unmeasured | Unmeasured | Unmeasured | 3.4 | 5.1 | 5.9 | Unmeasured |
| DOC [μm] | 93.8 | 101.2 | 107.9 | 108.4 | 124.6 | 132.4 | 134.3 | 133.5 |
| CT [MPa] | 84.5 | 89.3 | 107.6 | 88.3 | 94.0 | 90.9 | 88.8 | 82.2 |
| CS₃₀ [MPa] | 229.9 | 223.9 | 234.9 | 193.8 | 188.6 | 157.8 | 148.5 | 123.7 |
| CS₅₀ [MPa] | 138.8 | 145.1 | 161.0 | 133.1 | 121.1 | 114.2 | 111.1 | 96.2 |
| Abraded four-point bending | 254.0 | 266.4 | 272.3 | 246.8 | 227.0 | 205.8 | 198.8 | 180.7 |
| strength [MPa] | | | | | | | | |
| Explosive behavior | Absent | Absent | Present | Absent | Absent | Absent | Absent | Absent |

Samples Nos. 1 to 4 were each subjected to only the first ion exchange step, that is, ion exchange treatment once in total, and Samples Nos. 5 to 8 were each subjected to the first ion exchange step and the second ion exchange step, that is, ion exchange treatment twice in total. In the table, “Na100” means that the ion exchange treatment is performed through immersion in a molten salt in which the concentration of NaNO₃ is 100 mass %, “Na95/Li5” means that the ion exchange treatment is performed through immersion in a molten salt in which the concentration of NaNO₃ is 95 mass % and the concentration of KNO₃ is 5 mass %, and “K100” means that the ion exchange treatment is performed through immersion in a molten salt in which the concentration of KNO₃ is 100 mass %.

The K_{1C} is a value measured by an indentation fracture method (IF method) in conformity with JIS R1607, and is an average value over ten times of measurement. The K_{1C} is a value measured before the ion exchange of each glass sample.

The CS, the DOLK, the DOC, the CT, the CS₃₀, and the CS₅₀ were each calculated based on a stress profile obtained from a value measured with FSM-6000LE, or a stress profile obtained by synthesizing values measured with FSM-6000LE and SLP-2000.

The U_{CT limit} was measured by using the K_{1C} measured as described above and Equation (3).

The U_{CT} was measured by using the stress profile measured as described above and Equation (2).

The F_{IOX} was measured by using the U_{CT} limit and the U_{CT} measured as described above and Equation (1).

The abraded four-point bending strength was measured by performing an abrasion step of forming a shallow flaw on the surface of the chemically tempered glass, and then performing a bending fracture step of applying a bending stress to the chemically tempered glass to fracture the glass. Specifically, the abrasion step was performed with a test apparatus (abrasion apparatus) 7 illustrated in FIG. 9. The test apparatus 7 comprises a stainless steel-made hammer 8 having a weight of 550 g. The hammer 8 comprises a bar-shaped arm portion 9 and a head portion 10. One end portion (upper end portion) of the arm portion 9 is supported by a support shaft 11 so that the arm portion 9 can pivot around the support shaft 11. The head portion 10 is arranged in a side surface portion at the other end portion (lower end portion) of the arm portion 9. The head portion 10 has a collision surface 10a that collides with a main surface 13a of a chemically tempered glass 13 via sandpaper 12. The chemically tempered glass 13 is supported by a SUS-made surface plate 14 so that its main surface follows a vertical direction. The sandpaper (#180) 12 is fixed to the one main surface 13a of the chemically tempered glass 13.

In the abrasion step, after the head portion 10 of the arm portion 9 was arranged at a predetermined drop height H2 (100 mm), the arm portion 9 was caused to pivot toward the chemically tempered glass 13 by the action of gravity, to thereby cause the collision surface 10a of the head portion 10 to collide with the sandpaper 12 and the chemically tempered glass 13. Thus, a flaw shallower than the depth of compression of the compressive stress layer was formed on the main surface 13a of the chemically tempered glass 13.

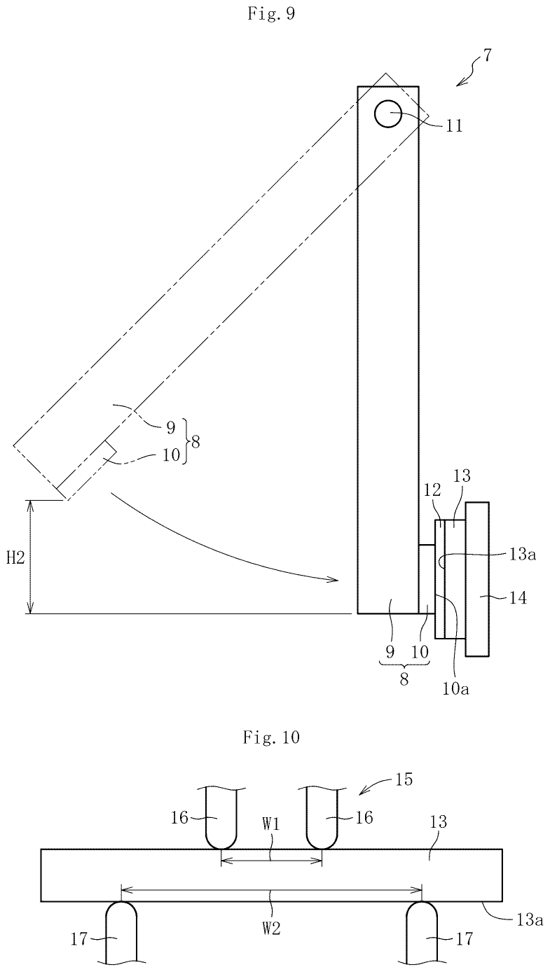

As illustrated in FIG. 10, a four-point bending tester 15 was used in the bending fracture step. The four-point bending tester 15 comprises pressure jigs 16 for pressurizing the chemically tempered glass 13 and support jigs 17 for supporting the chemically tempered glass 13.

In the bending fracture step, a bending stress applied to fracture the chemically tempered glass 13 was measured with the four-point bending tester 15. A method in conformity with JIS R1601 was used in a four-point bending test. Specific conditions of the four-point bending test were set as follows: a width W1 between the pressure jigs 16 of 20 mm; a width W2 between the support jigs 17 of 40 mm; and a descending speed of each of the pressure jigs 16 of 3 mm/min. The chemically tempered glass 13 was arranged so that the main surface 13a, on which the flaw had been formed in the abrasion step, was brought into contact with the support jigs 17.

The explosive behavior was evaluated as follows: when the chemically tempered glass was fractured by the above-mentioned pen drop test (see FIG. 7), a case in which 50 or more broken pieces were measured within 10 seconds immediately after the fracture was evaluated as “Present”, and a case in which less than 50 broken pieces were measured within 10 seconds immediately after the fracture was evaluated as “Absent”.

It can be recognized also from the results of Table 3 that in each of Samples Nos. 1, 2, and 4 to 8, in which the F_{IOX} is 1 or less, the chemically tempered glass does not show explosive behavior at the time of fracture, and in Sample No. 3, in which the F_{IOX} is more than 1, the chemically tempered glass shows explosive behavior at the time of fracture. In addition, it is found that while Samples Nos. 5 to 8 are each subjected to ion exchange treatment a plurality of times, the F_{IOX} is useful also for evaluating the explosive behavior at the time of fracture of such chemically tempered glass.

When Sample No. 7 and Sample No. 8 having comparable values of F_{IOX} are compared, it can be recognized that Sample No. 7, in which the K_{1C} is 0.8 MPa·m^{1/2} or more, has higher abraded four-point bending strength than Sample No. 8, in which the K_{1C} is less than 0.8 MPa·m^{1/2}.

In each of Samples Nos. 5 to 7, which was subjected to ion exchange treatment twice, the following results were obtained: a CS of 700 MPa or more; a CS₃₀ of 140 MPa or more; and a CS₅₀ of 100 MPa or more. Further, in each of Samples Nos. 6 and 7, the following result was obtained: a DOLK of 4.0 μm or more. The stress profile of each of Samples Nos. 5 to 8 has such an inflection portion X as shown in FIG. 2.

### INDUSTRIAL APPLICABILITY

The chemically tempered glass of the present invention can be utilized for, for example, a cover glass of a smartphone, a cellular phone, a tablet computer, a personal computer, a digital camera, a touch panel display, or any other display device, an automobile display device, or an automobile panel.

### REFERENCE SIGNS LIST

1 chemically tempered glass
1a main surface
1b end surface
2 compressive stress layer
3 tensile stress layer
4 chemically tempered glass (measurement sample)
5 stone surface plate
6 diamond pen
7 test apparatus
8 hammer
9 arm portion
10 head portion
11 support shaft
12 sandpaper
13 chemically tempered glass (measurement sample)
14 surface plate
15 tester
16 pressure jig
17 support jig

1. A chemically tempered glass, comprising a compressive stress layer having a compressive stress in a surface layer portion and comprising a tensile stress layer having a tensile stress in an inner portion,
wherein the chemically tempered glass has a temper filling rate Fox represented by Equation (A) of 0.75 or more and 1.00 or less:
$${F}_{IOX} = \frac{{U}_{CT}}{{U}_{CT limit}} \qquad ( A )$$
where
U_{CT} represents a tensile square area [MPa²·m] of the chemically tempered glass represented by Equation (B), and
U_{CT limit} represents an explosion threshold value [MPa²·m] of the chemically tempered glass represented by Equation (C);
$${U}_{CT} = {\int }_{DOC}^{\frac{t}{2}} {σ ( x )}^{2} dx \qquad ( B )$$
$${U}_{CT limit} = 1.618 {K}_{1 C} - 0.121 \qquad ( C )$$
where
“t” represents a thickness [m] of the chemically tempered glass,
DOC represents a depth of compression [m] of the compressive stress layer of the chemically tempered glass,
“x” represents a depth [m] of the chemically tempered glass from a surface thereof,
σ(x) represents a compressive stress value [MPa] at a depth “x” of the chemically tempered glass, and
K_{1C} represents a fracture toughness value [MPa·m^{1/2}] in a composition of a thickness center portion of the chemically tempered glass.

2. The chemically tempered glass according to claim 1, wherein the tensile square area U_{CT} is 0.90 MPa²·m or more.

3. The chemically tempered glass according to claim 1, wherein the fracture toughness value K_{1C} is 0.80 MPa·m^{1/2} or more.

4. The chemically tempered glass according to claim 1,
wherein the depth of compression DOC of the compressive stress layer is 90 μm or more, and
wherein the chemically tempered glass has a tensile stress value CT at a depth of t/2 of 80 MPa or more.

5. The chemically tempered glass according to claim 1,
wherein the thickness “t” is from 0.1 mm to 1.5 mm,
wherein the chemically tempered glass has a compressive stress value CS in the surface of 700 MPa or more,
wherein the chemically tempered glass has a compressive stress value CS₃₀ at a depth of 30 μm of 140 MPa or more, and
wherein the chemically tempered glass has a compressive stress value CS₅₀ at a depth of 50 μm of 100 MPa or more.

6. The chemically tempered glass according to claim 1, wherein the chemically tempered glass has a diffusion depth of layer DOLK of a potassium ion of 4 μm or more.

7. The chemically tempered glass according to claim 1, wherein a stress profile of the chemically tempered glass obtained by measuring a stress from the surface in a depth direction, with a compressive stress being a positive number and a tensile stress being a negative number, has an inflection portion.

8. The chemically tempered glass according to claim 1, comprising as the glass composition of the thickness center portion, in terms of mol %, 40% to 80% of SiO₂, 10% to 30% of Al₂O₃, 0% to 10% of B₂O₃, 0.1% to 25% of Na₂O, 0% to 10% of K₂O, 0.1% to 20% of Li₂O, 0% to 10% of MgO, and 0% to 10% of P₂O₅.

9. The chemically tempered glass according to claim 8, comprising as the glass composition of the thickness center portion, in terms of mol %, 50% to 70% of SiO₂, 10% to 20% of Al₂O₃, 0% to 3% of B₂O₃, 1% to 25% of Na₂O, 0% to 10% of K₂O, 3% to 12% of Li₂O, 0% to 5% of MgO, and 1% to 10% of P₂O₅.

10. The chemically tempered glass according to claim 1, comprising as the glass composition of the thickness center portion, in terms of mol %, 40% to 80% of SiO₂, 10% to 30% of Al₂O₃, 0% to 3% of B₂O₃, 5% to 25% of Na₂O, 0% to 5.5% of K₂O, 0% to 0.09% of Li₂O, and 0% to 10% of MgO.

11. The chemically tempered glass according to claim 1, wherein the chemically tempered glass is a crystallized glass.
